(19) United States
(12) Patent Application Publication
(10) Pub. No.: US 2003/0158768 A1
(43) Pub. Date: Aug. 21, 2003

(54) System supporting formation of business strategy

(76) Inventor: Tomohiko Maeda, Kawasaki (JP)

Correspondence Address: STAAS & HALSEY LLP, SUITE 700, 1201 NEW YORK AVENUE, N.W., WASHINGTON, DC, 20005, US

(21) Appl. No.: 10/365,428

(22) Filed: Feb. 13, 2003

(30) Foreign Application Priority Data
Feb. 15, 2002 (JP) 2002-039294
Oct. 28, 2002 (JP) 2002-313307

(51) Int. Cl. G06F 17/60

(52) U.S. Cl. 705/7

(57) ABSTRACT

Environmental data indicating an environment, such as “demand prediction”, “demand change”, “available plants” and the like, is inputted, and candidate models 5, such as “vertical integration”, “horizontal cooperation”, “coordination”, “outsourcing” and the like, are calculated. Furthermore, an arbitrary candidate model is selected from the candidate models, and ideal environmental data indicating the environment optimally suitable for the execution of the selected candidate model is calculated. Then, a difference between the environmental data and the ideal environmental data is analyzed, and an action plan is outputted based on the result of the analysis.

### BACKGROUND OF THE INVENTION

1. Field of the Invention

The present invention relates to, a model building program for presenting a practicable plan in an environment indicated by data, based on the environmental data prepared to decide the environment of a specific field or selecting one or more models from a plurality of models as candidate models, a model building method thereof and a model building device thereof. In particular, it relates to a model building program, for providing a specific and detailed action plan needed when a specific model is adopted and greatly contributes to strategy formation by the planning department of an enterprise, a model building method thereof and a model building device thereof.

2. Description of the Related Art

Conventionally, an enterprise often has a strategy planning department for planning a business strategy, a tactics planning department for planning its tactics and an action-plan department for preparing its action plans. In this case, the strategy planning department exclusively plans strategies, the tactics planning department builds tactics that reflect each strategy and optimize each department in charge, and the action-plan department prepares action plans that promote the efficiency of the relevant department in accordance with the strategy and tactics.

Such a planning mechanism functions in an environment where there is no need to modify a strategy in the middle or long term. However, in the current ever-changing environment, such a planning mechanism has the possibility of being reduced to a mere skeleton because it may no longer be appreciated, and of incurring poor achievements, decreasing sales and degenerating technologies. In this case, it is important to enable all of the strategy, the tactics and the action plans created by the respective departments (hereinafter comprehensively called the “plan”) to flexibly follow an environmental change and to efficiently predict such a plan, as requested.

For these reasons, recently, a variety of plans have been dynamically reviewed by applying information processing technologies to the planning of business plans. For example, a future plan has been predicted based on the current environment by utilizing model building software that calculates a candidate model presenting action plans based on environmental data that indicates current demand prediction, product value, yield and the like.

In this conventional model building software, a matrix process or a neural network process is used. In the matrix process, the respective relationship between values of environmental data and candidate models to be outputted is predetermined and a candidate model to be outputted is selected based on an inputted environmental data value. In the neural network process, samples of environmental data and outputted results are re-inputted and a training process is applied to the samples to automatically calculate optimal weight. Here, a candidate model is also selected by inputting environmental data. In this way, by using a matrix process or a neural network process, an optimal candidate model, such as reinforcement of horizontal cooperation, introduction of outsourcing and the like, in the case of building business strategies is outputted based on the inputted environmental data.

The neural network process is disclosed, for example, in Japanese Patent Laid-open No. 3-269777.

However, such conventional model building software simply calculates a candidate model, based on several items, such as demand prediction, the number of available plants and the like, instead of all of the necessary items. Therefore, an outputted candidate model is not always optimal. Accordingly, a final model must be selected by a person belonging to each planning department.

As described above, since the conventional model building software simply outputs a candidate model that is judged to be optimal, based on current environmental data, including current predictions for reference, it cannot be expected to greatly improve the planning efficiency of persons belonging to a planning department. Accordingly, it cannot be expected to greatly contribute to the improvement of such planning.

For these reasons, how to realize software and a device that greatly contribute to planning by the planning department of an enterprise is a very important issue. In particular, it is preferable to confirm what should be done with a specific and detailed action plan when a specific strategy is adopted.

### SUMMARY OF THE INVENTION

It is an object of the present invention to provide a model building program, for greatly contributing to planning by the planning department of an enterprise by providing a specific and detailed action plan needed when a specific model is adopted, a model building method thereof and a model building device thereof, in order to solve the problems described in the above prior art.

A model building program enabling a computer to perform the process of selecting and outputting one or more models indicating a practicable plan in an environment indicated by environmental data, based on the environmental data that is used to decide the environment of a specific field, from a plurality of models as candidate models, is recorded on a computer-readable storage medium in one aspect of the present invention. This computer performs a target model selection process for selecting a target model indicating ideal environmental data from a plurality of models and an ideal environmental data calculation process for calculating ideal environmental data indicating an environment suitable for the execution of the target model selected by this target model selection process.

According to this aspect, a computer can select a target model indicating ideal environmental data from a plurality of models and calculate ideal environmental data indicating an environment suitable for the execution of the selected target model. In this way, a computer can indicate the ideal environment of a specific adopted model, which greatly contributes to strategy formation by the planning department of an enterprise.

On the storage medium in another aspect of the present invention, the model building program further performs a difference calculation process that calculates the difference between the actual environmental data and the ideal environmental data as difference data, and an action plan output process that outputs a practicable action plan effective in bringing the actual environmental data close to the ideal environmental data, based on this difference data.

In this way, a computer can provide a specific and detailed action plan needed when a specific model is adopted, which greatly contributes to strategy formation by the planning department of an enterprise.

On the storage medium in another aspect of the present invention, the model building program further performs an evaluation calculation process that calculates evaluation data, indicating evaluation in the specific field, of the actual environmental data, and an ideal evaluation data calculation process that calculates ideal evaluation data, indicating evaluation in the specific field, that is needed when the selected model is adopted, based on the ideal environmental data.

According to this aspect, a computer can make an evaluation in a specific field, based on actual environmental data, and calculate the ideal evaluation in the specific field, that is needed when the selected model is adopted, based on ideal environmental data. In this way, a computer can provide a specific and detailed action plan needed when a specific model is adopted, and make an evaluation when the model is adopted, which greatly contributes to strategy formation by the planning department of an enterprise.

A model building method, which is another aspect of the present invention, selects a target model indicating ideal environmental data from a plurality of models in order to select and output one or more models indicating a practicable plan in the environment indicated by the environmental data, based on the environmental data used to decide about the environment in a specific field, and calculates the ideal environmental data indicating the environment suitable for the execution of the selected target model.

According to this aspect, the model building method can select a target model indicating ideal environmental data from a plurality of models and calculate ideal environmental data indicating an environment suitable for the execution of the selected target model. In this way, the method can indicate the ideal environment needed when a specific model is adopted, which greatly contributes to strategy formation by the planning department of an enterprise.

A model building device, which is another aspect of the present invention, selects and outputs one or more models indicating a practicable plan in a specific environment indicated by environmental data, from a plurality of models as candidate models, based on the environmental data used to decide the environment in a specific field. The device comprises a target model selection unit selecting a target model indicating ideal environmental data from the plurality of models and an ideal environmental data calculation unit calculating ideal environmental data indicating the environment suitable for the execution of the target model selected by the target model selection unit.

According to this aspect, the device can select a target model indicating ideal environmental data from a plurality of models and calculate ideal environmental data suitable for the execution of the selected target model. In this way, the device can indicate the ideal environment needed when a specific model is adopted, which greatly contributes to strategy formation by the planning department of an enterprise.

### BRIEF DESCRIPTION OF THE DRAWINGS

The present invention will be more apparent by referencing the following detailed descriptions outlined in the accompanying drawings.

FIG. 1 shows the concept of a model building device according to the first preferred embodiment.

FIG. 2 shows the configuration of the model building device according to the first preferred embodiment.

FIG. 3 shows an example of an input screen used to input the environmental data 3 shown in FIG. 1.

FIG. 4 shows the relationship between the candidate model 5 and the ideal environmental data 8 which are shown in FIG. 1.

FIG. 5 shows the co-relationship between the environmental data 3, the ideal environmental data 8, the difference data and the action plan which are shown in FIG. 1.

FIG. 6 shows a neural network used to calculate the candidate model 5 shown in FIG. 1.

FIG. 7 shows the basic units of a hierarchical network.

FIG. 8 shows the hierarchical configuration of the neural network shown in FIG. 6.

FIG. 9 shows the concept of a model building device according to the second preferred embodiment.

FIG. 10 shows the configuration of the model building device according to the second preferred embodiment.

FIG. 11 shows an evaluation table used for the evaluation calculation shown in FIG. 9.

FIG. 12 shows example outputs of the environmental evaluation data and the ideal environmental evaluation data.

FIG. 13 shows the configuration of a computer system according to the third preferred embodiment.

FIG. 14 shows the main body shown in FIG. 13.

FIG. 15 is a flowchart showing a control process performed in a computer system 100 by executing a model building program.

FIG. 16 is a flowchart showing an analysis process.

FIG. 17 is a flowchart showing a data management process.

FIG. 18 is a flowchart showing an input/output process.

FIG. 19 is a flowchart showing a candidate model calculation process.

FIG. 20 is a flowchart showing an ideal environmental data calculation process.

FIG. 21 is a flowchart showing a difference analysis process.

FIG. 22 is a flowchart showing an action plan extraction process.

### DESCRIPTION OF THE PREFERRED EMBODIMENTS

The preferred embodiments of a model building program, a model building method and a model building device are described below in detail with reference to the drawings. In the first preferred embodiment, a model building device for calculating a specific and detailed action plan needed when a specific model is adopted, is described. In the second preferred embodiment, a model building device for calculating the evaluation needed when a specific model is adopted, is described. In the third preferred embodiment, a computer system for executing a model building program is described.

[First Preferred Embodiment]

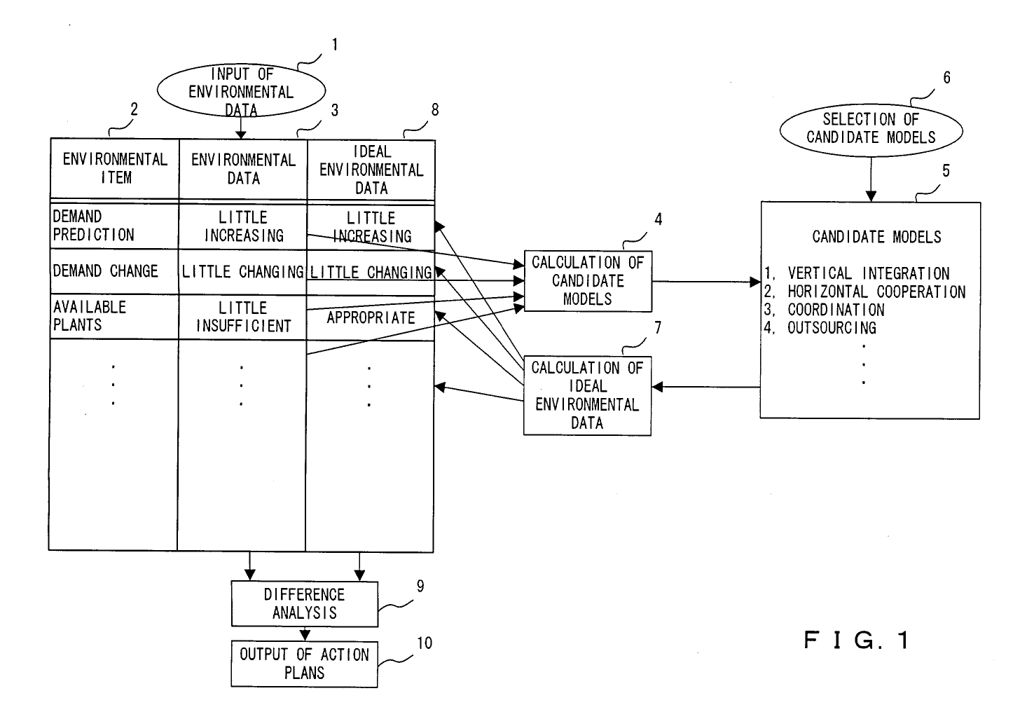

Firstly, the concept of a model building device according to this preferred embodiment is described. FIG. 1 shows the concept of a model building device according to the first preferred embodiment.

As shown in FIG. 1, this model building device performs a process of calculating a candidate model indicating a strategy, such as vertical integration, horizontal cooperation, coordination, outsourcing or the like, based on environmental data indicating demand prediction, demand change, available plants and the like, and performs a process of calculating ideal environmental data indicating an environment optimally suited to execute a candidate model, based on the candidate model. In other words, this model building device not only conventionally select a candidate model, based on environmental data, but also presents environmental data optimally suited for this candidate model that is needed when a specific candidate model is selected. This is because the comparison of optimal environmental data with current data can greatly contribute to strategy formation by the planning department of an enterprise when a specific candidate model is adopted. Here, optimal or ideal environmental data means the best environment under a specific condition from a plurality of comparative targets. However, if for any condition that is met, a plurality of segments for the optimal or ideal environment can be selected. If there is a plurality of segments for the optimal or ideal environment indicated, then the ideal environmental data is outputted for each of the plurality of segments of the environment. Therefore, as a result, a plurality of segments of the ideal environmental data is presented.

When this model building device calculates a candidate model, firstly, environmental data 3 for an environmental item 2 indicating “demand prediction”, “demand change”, “available plants” and the like are inputted (input of environmental data 1). In this example, “little increasing”, “little changing” and “little insufficient” are inputted for the items of “demand prediction”, “demand change” and “available plants”, respectively.

The model building device calculates a strategy model that can be used in the environment indicated by the environmental data 3 (calculation of candidate models 4) and outputs a plurality of models as candidate models 5. The calculation of candidate models 4 gives priority to candidate models in descending order of matching environments indicated by the environmental data 3. Therefore, as shown in FIG. 1, candidate models for “1. vertical integration”, “2. horizontal cooperation”, “3. coordination” and “4. outsourcing” are outputted according to the degree of matching with the environment.

This model building device also calculates (calculation of ideal environmental data 7) and outputs environmental data optimally suited for the execution of the selected candidate models by selecting an arbitrary candidate model from the candidate models 5 (selection of candidate models 6). For example, if “1. vertical integration” is selected, the calculation of ideal environmental data 7 outputs “little increasing”, “little changing” and “little insufficient” for items of demand prediction, demand change and available plants, respectively. These values in total indicate whether it is ideal to conduct vertical integration if demand increases gradually and whether the number of plants used to manufacture products is a little insufficient. Although in this example, “1. vertical integration” with top priority is selected, in reality, a business strategy is not always determined only by the degree of matching with the environment. This model building device can also calculate the ideal environmental data by selecting another candidate model with a pretty low degree of matching when executing the candidate model.

Furthermore, the model building device compares environmental data 3 and ideal environmental data 8 and extracts the difference between them (difference analysis 9). Then, the device outputs the difference as difference data. The model building device outputs a specific and detailed plan to be executed in order to bring the environmental data 3 close to the ideal environmental data 8, as an action plan (output of action plan 10).

In other words, this model building device greatly contributes to strategy formation by the planning department of an enterprise by not only displaying ideal environmental data corresponding to a selected candidate model in relation to environmental data, but by also clarifying the difference between them and providing a specific and detailed action plan.

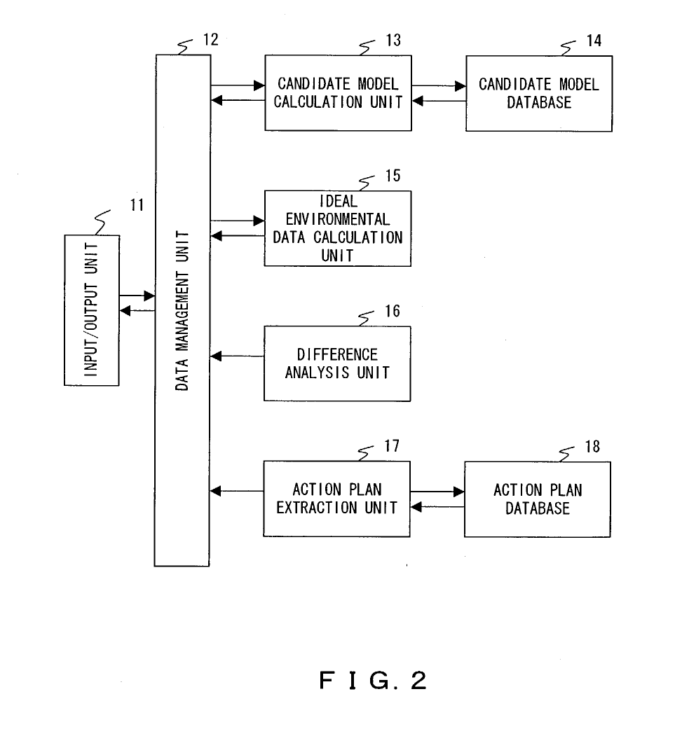

Next, the configuration of this model building device is described. FIG. 2 shows the configuration of the model building device according to the first preferred embodiment. In FIG. 2, the model building device comprises an input/output unit 11, a data management unit 12, a candidate model calculation unit 13, a candidate model database 14, an ideal environmental data calculation unit 15, a difference analysis unit 16, an action plan extraction unit 17 and an action plan database 18.

The input/output unit 11 is connected to the data management unit 12, and writes/reads data into/from the data management unit 12. When environmental data 3 is inputted to the input/output unit 11, the data management unit 12 stores the environmental data 3, and also outputs the environmental data 3 to the candidate model calculation unit 13. The candidate model calculation unit 13 calculates candidate models 5 that can be used in the environment indicated by the environmental data 3 and outputs the models to the data management unit 12 after giving priority to them.

The data management unit 12 stores the usable candidate models 5 received from the candidate model calculation unit 13 and outputs the models to the input/output unit 11. The input/output unit 11 outputs the usable candidate models 5, and if an arbitrary candidate model is selected from the usable candidate models 5, it outputs the selected candidate model to the data management unit 12. The data management unit 12 stores the selected candidate model 5 and also outputs the model to the ideal environmental data calculation unit 15.

The ideal environmental data calculation unit 15 calculates the environment optimally suited for the execution of the selected candidate model and outputs the environment to the data management unit 12 and the difference analysis unit 16 as ideal environmental data 8. Furthermore, the difference analysis unit 16 conducts difference analysis by comparing the environmental data 3 stored in the data management unit 12 with the ideal environmental data 8 and outputs the result of the difference analysis to the data management unit 12 and the action plan extraction unit 17 as difference data.

The action plan extraction unit 17 extracts an action plan to be executed in order to bring the environmental data 3 close to the ideal environmental data 15, from action plans stored in the action plan database 18 and outputs the plan to the data management unit 12. The data management unit 12 stores the ideal environmental data 8, difference data and action plan, and outputs them to the input/output unit 12.

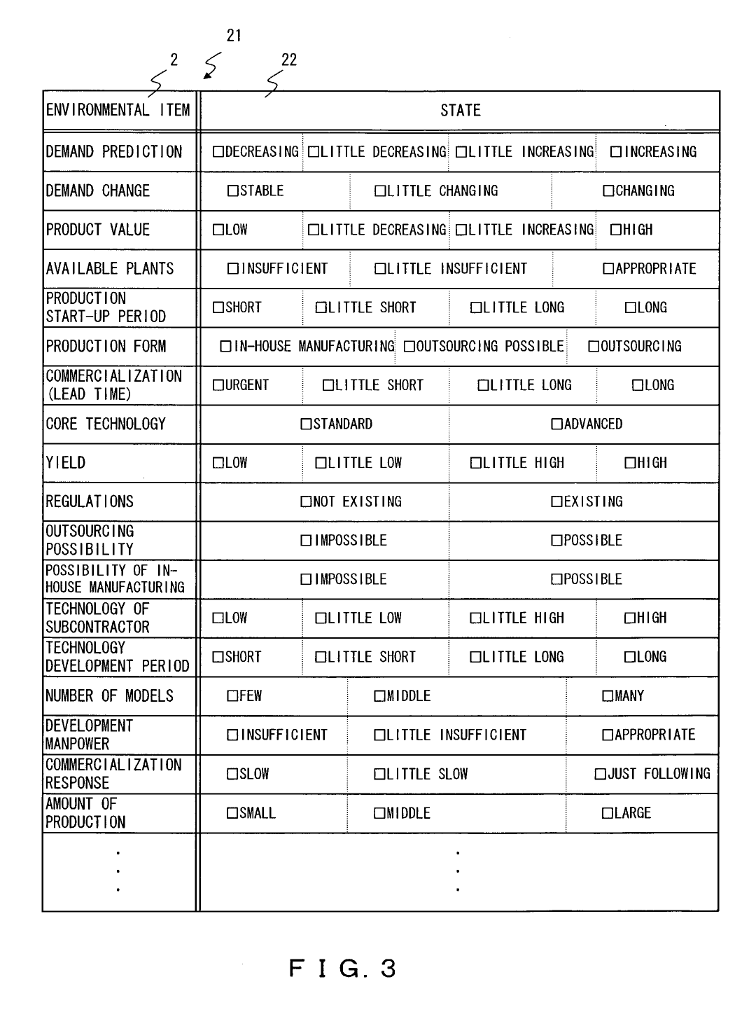

Next, the input of environmental data 3 is described in more detail. FIG. 3 shows an example of an input screen used to input the environmental data 3 shown in FIG. 1. In FIG. 3, an environmental data input screen 21 displays environmental items 2 and a data input unit 22. The data input unit 22 displays available values for each of the environmental items 2. By selecting values for the items displayed on the data input unit 22, environmental data 3 is generated. For example, the data input unit 22 displays four values of “decreasing”, “little decreasing” and “little increasing” and “increasing” for an environmental item “demand prediction”, and by selecting an arbitrary value from the four values, the value of demand prediction is defined.

Similarly, the data input unit 22 displays three values of “stable”, “little changing” and “changing” and three values of “insufficient”, “little insufficient” and “appropriate” for the environmental items “demand change” and “available plants”, respectively. Furthermore, the unit 22 displays four values of “short”, “little short”, “little long” and “long” and three values of “in-house manufacturing”, “outsourcing possible” and “outsourcing” for the environmental items “production preparation” and “production form”, respectively.

By displaying values to be used as environmental items 2 on the data input unit and selecting a value from the values displayed on the input unit 22, environmental data 3 can be generated.

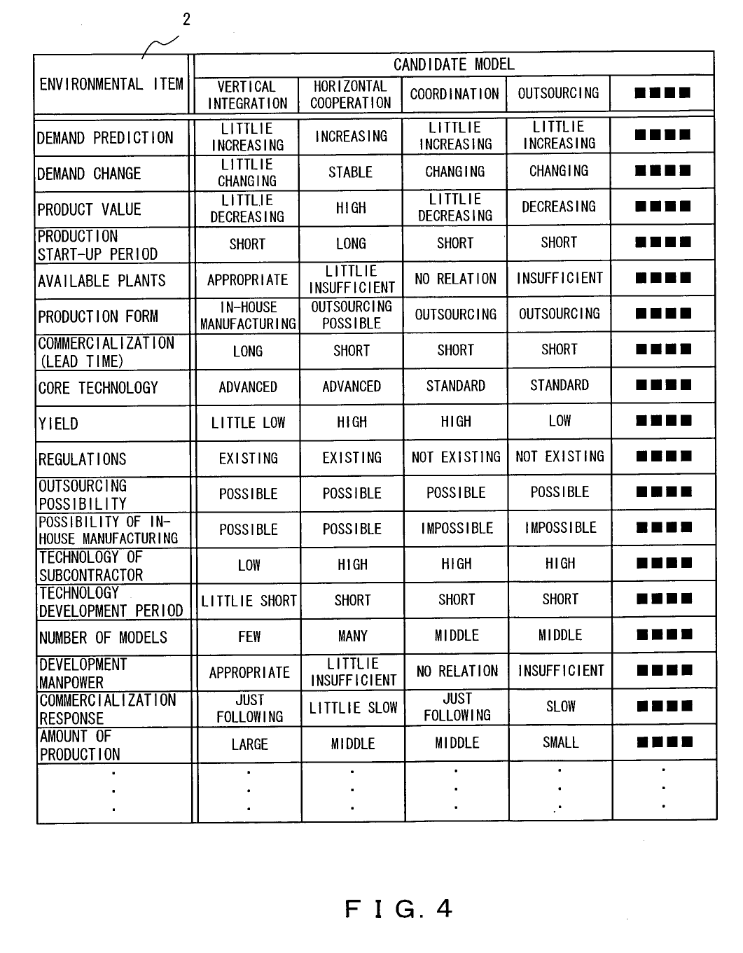

Next, the relationship between a candidate model 5 and ideal environmental data 8 is described. FIG. 4 shows the relationship between a candidate model 5 and ideal environmental data 8. Although a candidate model 5 indicates a practicable plan in the environment indicated by the environmental data 3, the optimal environment in which a candidate model is executed is different for each candidate model. For example, if “vertical integration”, “horizontal cooperation”, “coordination” and “outsourcing” are outputted as practical candidate models, the ideal environmental data 8, indicating the optimal environment in which a candidate model is executed, will have different values for each candidate model. This ideal environmental data 8 has environmental items 2 corresponding to actual environmental data 3, and the optimal environment, in which each candidate model is executed, is designated using these environmental items 2.

In FIG. 4,the environmental items 2 are “demand prediction”, “demand change”, “available plants”, “production preparation” and “production form”. In this case, the environment optimally suited to execute a candidate model “vertical integration” is indicated using the respective parameter values of the environmental items, for example, “little increasing”, “little changing”, “appropriate”, “short” and “in-house manufacturing” for “demand prediction”, “demand change”, “available plants”, “production preparation” and “production form”, respectively. Similarly, the environment optimally suited to execute a candidate model “horizontal cooperation” is indicated using parameter values, “increasing”, “stable”, “little insufficient”, “long” and “outsourcing possible” for “demand prediction”, “demand change”, “available plants”, “production preparation” and “production form”, respectively.

The environment optimally suited to execute a candidate model “coordination” is indicated using parameter values, “little increasing”, “changing”, “irrelevant”, “short” and “outsourcing” for “demand prediction”, “demand change”, “available plants”, “production preparation” and “production form”, respectively. Here, the “irrelevant” of “available plants” indicates that the execution of the candidate model “coordination” does not depend on the parameter of “available plants”. Furthermore, the environment optimally suited to execute the candidate model “outsourcing” is indicated using parameters, “little increasing”, “changing”, “insufficient”, “short” and “outsourcing” for “demand prediction”, “demand change”, “available plants”, “production preparation” and “production form”, respectively.

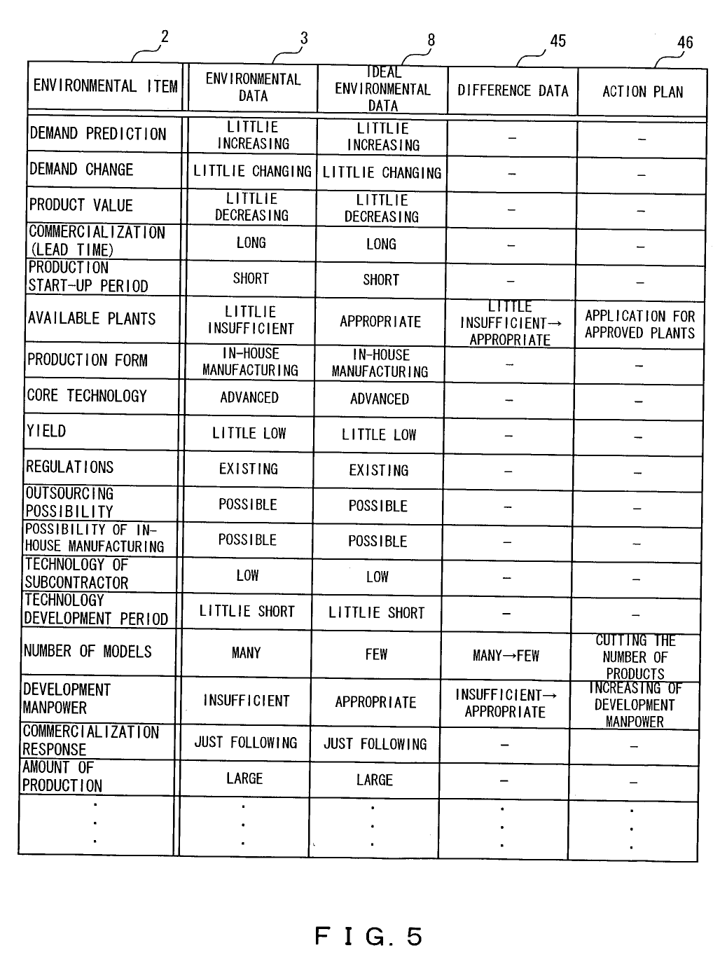

Next, the difference data that is calculated using actual environmental data 3 and ideal environmental data 8, and the action plan that is extracted together with the difference data are described. FIG. 5 shows the co-relationship between environmental data 3, ideal environmental data 8, difference data and an action plan. Each of the environmental data 3 and ideal environmental data 8 has the respective parameter values for the environmental items 2, for example, “demand prediction”, “demand change”, “available plants”, “production preparation” and “production form”. The difference data 45 can be obtained by comparing the parameter value of each environmental item 2 from the actual environmental data 3 with the parameter value for each environmental item from the ideal environmental data 8 and extracting the environmental items with a difference between them. In FIG. 5, the environmental data 3 and the ideal environmental data 8 can be different in the parameter values of environmental items, “available plants”, “number of models” and “development manpower” but are the same in those of the other environmental items. Therefore, the difference data 45 is stored as the respective parameter values for three environmental items, “available plants”, “number of models” and “development manpower”.

An action plan 46 is extracted from action plans stored in the action plan database 18, based on the difference data 45. In FIG. 5, “application for approved plants” is extracted as an action plan by changing the parameter value from, “little insufficient” for the environmental item “available plants” in the environmental data 3 to the parameter value, “appropriate” for the equivalent item from the ideal environmental data 8. “Cutting of the number of products” is extracted as an action plan by changing the parameter value “many” for the environmental item “number of models” in the environmental data 3 to the parameter value “few” for the equivalent item from the ideal environmental data 8. Furthermore, “increase of development manpower” is extracted as an action plan effective by changing the parameter value “insufficient” for the environmental item “development manpower” in the environmental data 3 to the parameter value “appropriate” for the equivalent item from the ideal environmental data 8.

By calculating a candidate model 5, based on environmental data 3 and calculating ideal environmental data 8, based on the candidate model 5, and comparing the environmental data 3 with the ideal environmental data 8, an action plan can be extracted.

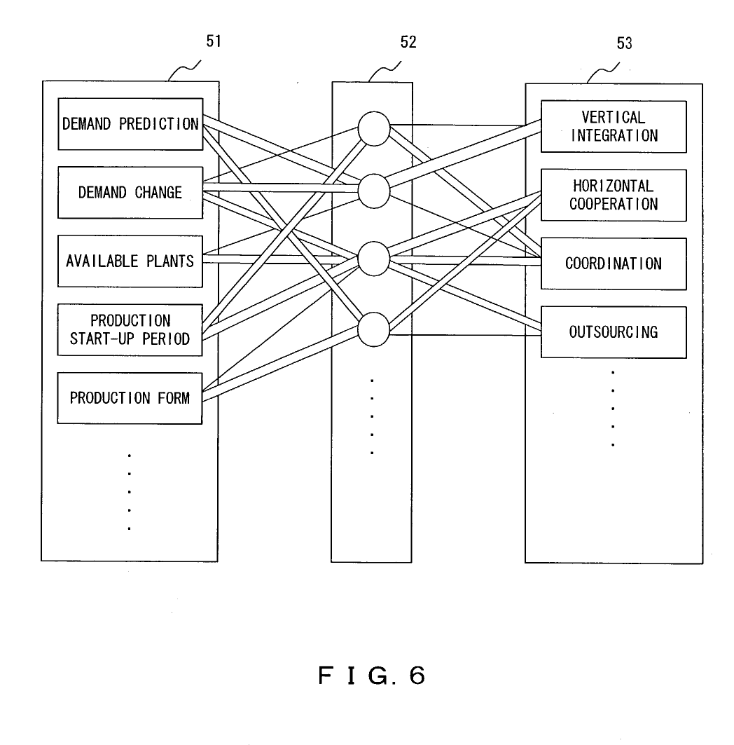

Next, the respective calculation of a candidate model 5 and ideal environmental data 8 is described. The candidate model 5 and ideal environmental data 8 are calculated using a neural network, a matrix or the like. FIG. 6 shows a neural network used to calculate a candidate model 5. In FIG. 6, the neural network comprises an input layer 51, inputting data to the neural network, a middle layer 52, calculating data and an output layer 53, outputting a result. The input layer 51 has input items corresponding to the environmental items of the environmental data 3, such as “demand prediction”, “demand change”, “available plants”, “production preparation”, “production form” and the like. The middle layer 52 has a plurality of neurons. The output layer 53 has output items corresponding to candidate models 5, such as “vertical integration”, “horizontal cooperation”, “coordination”, “outsourcing” and the like.

Furthermore, each of the input items of the input layer 51 is connected to the neurons of the middle layer 52, and each of the neurons of the middle layer 52 is connected to the output items of the output layer 53. In this case, a respective weight provided to the connection, between an input item and a neuron, between a neuron and an output item and between connections, is variable. The connection and its weight are determined by a training process using samples of input data and an output result. In this example, this training process is conducted using a back propagation method, which is well known as a learning method in a neural network.

Here, the back propagation method is described.

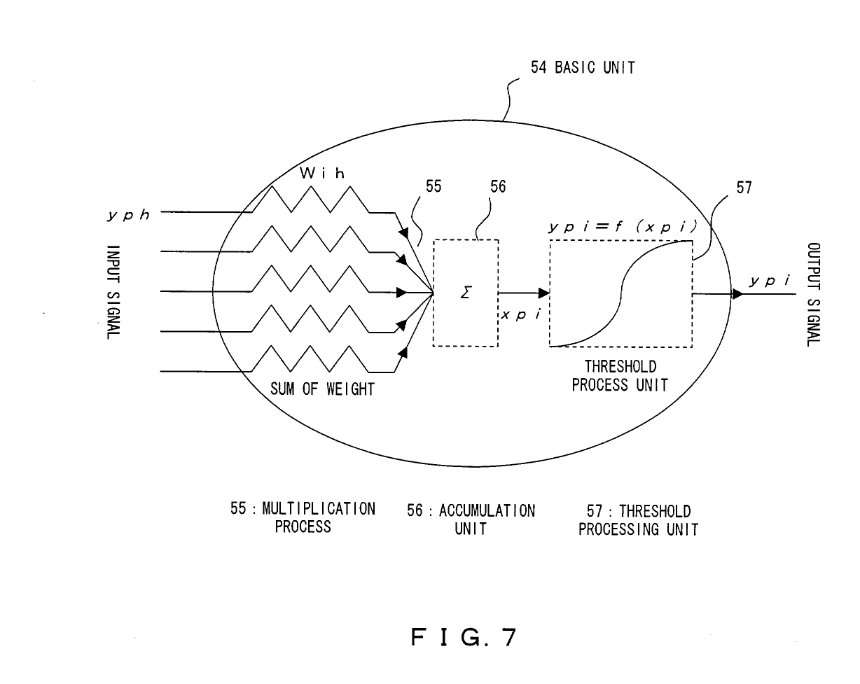

The neural network shown in FIG. 6 is basically a hierarchical network composed of a plurality of units called “basic units” each with a kind of node and an internal joint having a weight. FIG. 7 shows the configuration of the basic unit 54.

This basic unit 54 is a multi-input one-output system. The basic unit 54 comprises a multiplication processing unit 55, multiplying a plurality of inputs by each internal joint weight, an accumulation processing unit 56, summing all the multiplication results and a threshold processing unit 57, applying a non-linear threshold process to this accumulated value, and a process for outputting one final output.

If it is assumed that h and i layers are pre- and post-stages, respectively, this accumulation processing unit 56 and threshold processing unit 57 execute the following equations (1) and (2), respectively.

$${x}_{pi} = {\sum }_{h} {y}_{ph} {w}_{ih} \qquad ( 1 )$$

yₚᵢ=1/(1+exp(−xₚᵢ+θᵢ)) (2)

However, in this case, the following is assumed.

h: Unit No. of the h layer

i: Unit No. of the i layer

P: Pattern No. of an input signal

θᵢ: Threshold of the i-th unit of the i layer

Wih: Weight of internal joint weight between the h and i layers

xₚᵢ: Sum of the products of inputs from each unit of the h layer to the i-th unit of the i layer

yₚₕ: Input from the h-th unit of the h layer against the input signal of the p-th pattern

yₚᵢ: Output from the i-th unit of the i layer against the input signal of the p-th pattern

In FIG. 6, a hierarchical network is composed by hierarchically connecting many basic units 54 with such a configuration, shown in FIG. 7, using an input unit 54-h that distributes and outputs input signal values without modification and where a parallel data processing function to convert input patterns (input signals) into corresponding output patterns (output signals) is realized.

In the back propagation method, the weight Wᵢₕ and threshold θᵢ of a hierarchical network are automatically and appropriately adjusted by the feedback of an error and when the calculation of the relationship between a candidate model and environmental data is learned. As is clear from the equations (1) and (2), the adjustment of the weight Wᵢₕ and that of the threshold θᵢ must be simultaneously conducted. However, this is hard work in which the weight Wᵢₕ and threshold θᵢ interfere with each other. Therefore, this applicant has proposed to handle the threshold θᵢ as a weight by providing a unit always outputting “1” to the h layer on the input side and assigning the threshold θᵢ to the output as a weight, as disclosed in Japanese Patent Laid-open No. 1-173257. By doing this, equations (1) and (2) can be expressed as follows:

$${x}_{pi} = {\sum }_{h} {y}_{ph} {w}_{ih} \qquad ( 3 )$$

yₚᵢ=1/(1+exp(−xₚᵢ)) (4)

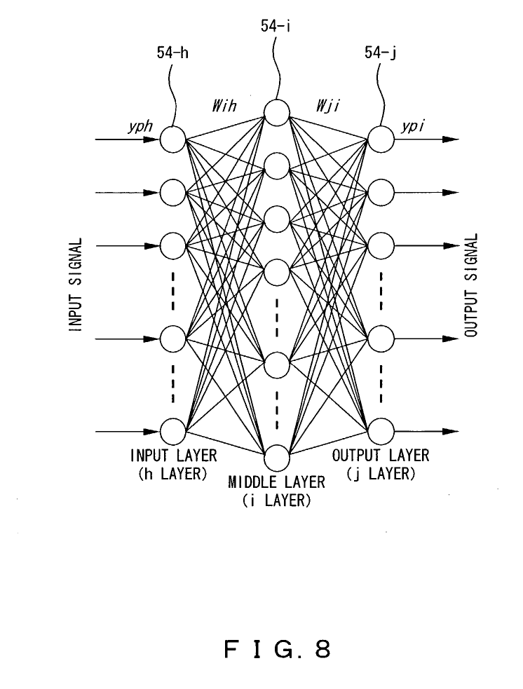

Next, the learning method by the back propagation method is described based on the equations (3) and (4). In this description it is assumed that the neural network shown in FIG. 6 is a hierarchical network with three layers of h, i and j in this order from the side shown in FIG. 8.

By analogy of equations (3) and (4), the following equations (5) and (6) can be obtained.

$${x}_{pj} = {\sum }_{i} {y}_{pi} {w}_{ji} \qquad ( 5 )$$

yₚⱼ=1/(1+exp(−xₚⱼ)) (6)

However, in this case, the following is assumed.

j: Unit No. of the j layer

Wⱼᵢ: Weight of an internal connection between i and j layers

xₚⱼ: Sum of the products of inputs from each unit of the i layer to the j-th unit of the j layer

yₚⱼ: Output from the j-th unit of the j layer against the input signal of the p-th pattern

In the training of this neural network, firstly, the difference [dₚⱼ−yₚⱼ] between an output pattern yₚⱼ, from the output layer that is outputted when an input pattern for training is presented, and a teacher pattern dₚⱼ that is the signal for the output pattern yₚⱼ to receive (the teacher signal to the j-th unit of the j layer against the input signal of the p-th pattern) is calculated. Then, the following equation is calculated.

αₚⱼ=yₚⱼ(1−yₚⱼ)(dₚⱼ−yₚⱼ) (7)

Then, the amount of weight ΔWⱼᵢ(t) to update between the i and j layers is calculated as follows:

$$Δ {W}_{ji} ( t ) = ϵ {\sum }_{p} {α}_{pj} {y}_{pi} + ζ Δ {W}_{ji} ( t - 1 ) \qquad ( 8 )$$

However, in this case, the following is assumed.

ε: Learning constant

ξ: Momentum

t: Number of times of learning

Here, the amount of weight to update determined in the previous update cycle ΔWⱼᵢ(t−1), is added in order to improve the learning speed.

Then, firstly, the following equation is calculated.

$${β}_{pi} = {y}_{pi} ( 1 - {y}_{pi} ) {\sum }_{j} {α}_{pj} {W}_{ji} ( t - 1 ) \qquad ( 9 )$$

Then, the amount of weight ΔWᵢₕ(t) to update between the h and i layers is calculated as follows:

$$Δ {W}_{ih} ( t ) = ϵ {\sum }_{p} {β}_{pi} {y}_{ph} + ζ Δ {W}_{ih} ( t - 1 ) \qquad ( 10 )$$

Then, weight Wji and Wih, in which an output pattern yₚⱼ from the output layer that is outputted when an input pattern for learning is presented and a teacher pattern dpj which is a signal for the output pattern yₚⱼ to take are matched. This is learned by repeatedly determining the weight for subsequent update cycles, based on the calculated amount to update as follows.

Wⱼᵢ(t)=Wⱼᵢ(t−1)+ΔWⱼᵢ(t)

Wᵢₕ(t)=Wᵢₕ(t−1)+ΔWᵢₕ(t) (11)

For the details of the back propagation method, see D. E. Rumelhart, G. E. Hinton, and R. J. Williams, “Learning Internal Representations by Error Propagation”, PARALLEL DISTRIBUTED PROCESSING, Vol.1, The MIT Press (1986).

Although, in this example, the back propagation method is used for the training method, another method, such as a virtual impedance method, can also be used.

By using this type of neural network, the relationship between input data and output data, specifically, the relationship between environmental data 3 and a candidate model 5 can be automatically calculated. By providing the input and output layers of the neural network with a candidate model 5 and ideal environmental data 8, respectively, the relationship between the candidate model 5 and ideal environmental data 8 can also be automatically calculated. Either a different independent neural network or the same neural network can also be used for the calculation of a candidate model 5 and that of ideal environmental data 8. Furthermore, although, in the above description, a neural network with a single middle layer is used, a neural network with a plurality of middle layers can also be used.

If a matrix is used to calculate a candidate model 5, a candidate model 5 to be outputted against the combination of a plurality of segments of environmental data 3 must be predetermined. If a matrix is used to calculate ideal environmental data 8, the combination of each model included in candidate models 5 and ideal environmental data 8 must be predetermined. It there is a plurality of combinations of a specific candidate model and ideal environmental data 8, all the combinations are stored and ideal environmental data 8 closest to the inputted environmental data 3 can be used.

As described above, in the first preferred embodiment, a candidate model 5 is calculated based on environmental data 3 and the ideal environmental data 8 is further calculated based on the candidate model 5. Therefore, the environment ideal for the execution of the candidate model can be calculated.

Although in the first preferred embodiment, a model building device has been described, a model building program for enabling a computer to perform the same process can also be obtained by realizing the configuration of the model building device by software.

Although in the first preferred embodiment, “demand prediction”, “demand change”, “available plants” and the like are used for the environmental items of the environmental data 3 and ideal environmental data 8, an arbitrary item can be set to behave as an environmental item, and the number of items can also be arbitrarily set.

Furthermore, although in the first preferred embodiment, a model building device to be used to build a strategy in a business field has been described, the present invention can be widely used to build a model in an environment where a plurality of factors are complicated and related.

[Second Preferred Embodiment]

In the second preferred embodiment, a model building device that uses the environmental data 3 and the ideal environmental data 8 described in the first preferred embodiment and evaluates the environment indicated by the environmental data 3 and the execution of a candidate model 5 by the model building device is described.

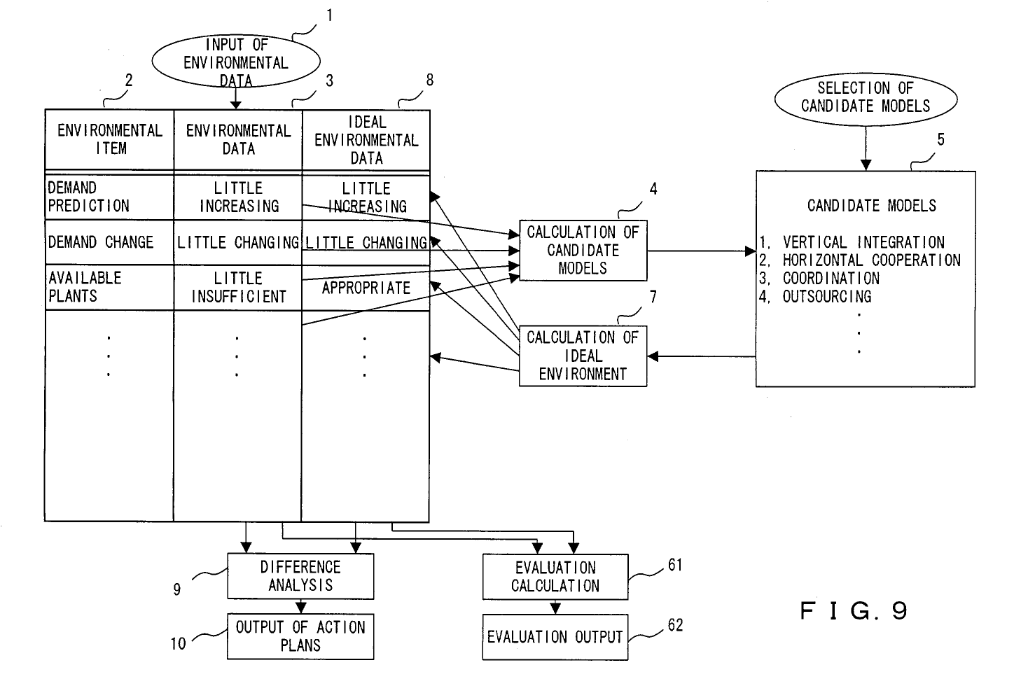

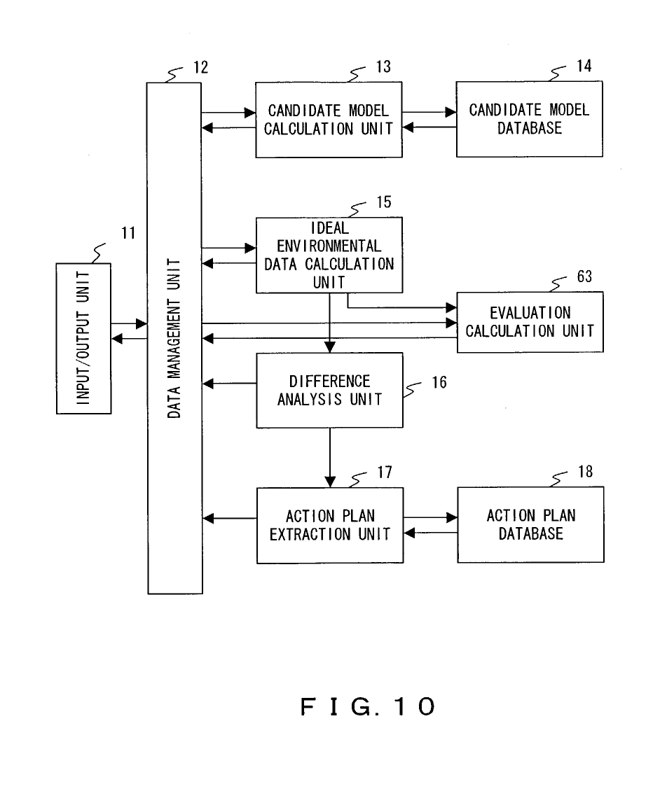

FIG. 9 shows the concept of a model building device according to the second preferred embodiment. FIG. 10 shows the configuration of a model building device according to the second preferred embodiment. As shown in FIGS. 9 and 10, this model building device is configured by adding an evaluation calculation unit 63 to the model building device of the first preferred embodiment, and it performs the calculation of an evaluation 61 and outputs the evaluation 62. Except for that point, this model building device is the same as that of the first preferred embodiment. Therefore, the same reference numbers are attached to the same components as those of the first preferred embodiment, and their detailed descriptions are omitted here.

Environmental data 3 inputted to this model building device (input of environmental data 1) is outputted from the data management unit 12 to the evaluation calculation unit 63. If ideal environmental data 8 is calculated by the ideal environmental data calculation unit 15 (calculation of ideal environmental data 7), the ideal environmental data 8 is outputted to the evaluation calculation unit 63.

Upon receipt of the environmental data 3, the evaluation calculation unit 63 evaluates a candidate model, based on the environmental data 3 (calculation of evaluation 61) and outputs the evaluation to the data management unit 12 (output of evaluation 62). If ideal environmental data 8 is inputted, the evaluation calculation unit 63 evaluates a candidate model, based on the ideal environmental data 8 (calculation of evaluation 61) and outputs the evaluation to the data management unit 12 (output of evaluation 62).

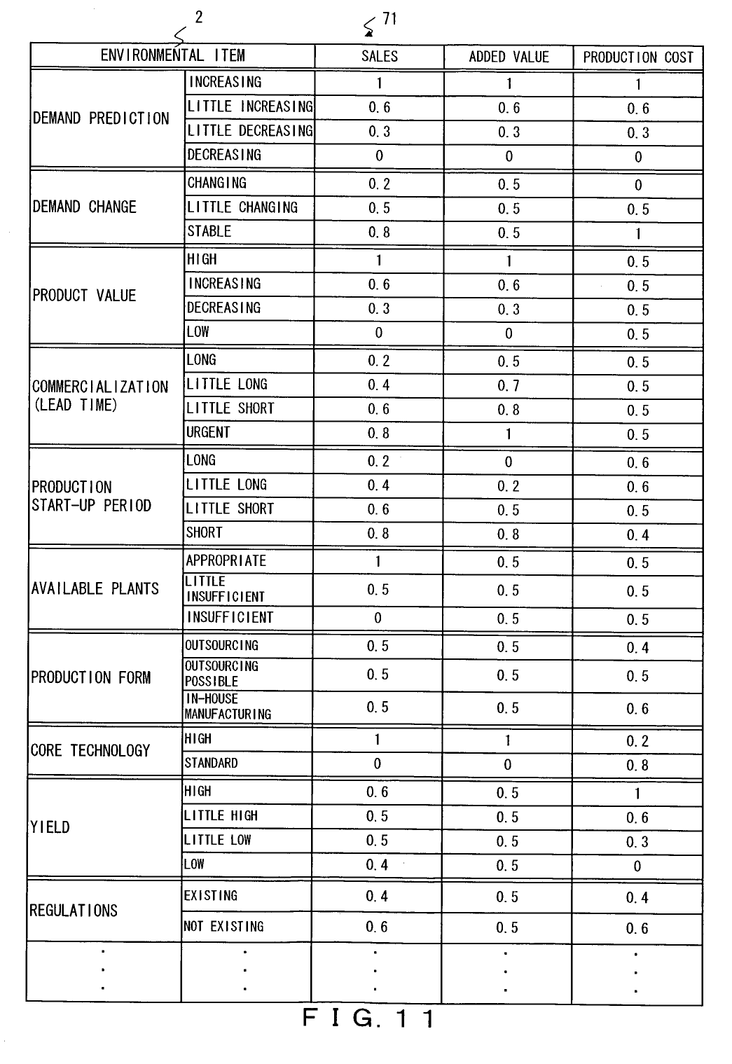

Next, the evaluation calculation of the evaluation calculation unit 63 is described. The evaluation calculation unit 63 calculates an evaluation using an evaluation table shown in FIG. 11. The evaluation table 71 relates each of the parameter values of environmental items 2 to be taken by the environmental data 3 and the ideal environmental data 8 to an arbitrary evaluation item and stores it. In FIG. 11, the evaluation table 71 has evaluation items, “sales”, “added value” and “production cost”, and relates each of the values of “sales”, “added value” and “production cost” to each parameter value of each environmental item 2.

For example, if the parameter value environmental item “demand prediction” is “increasing”, the values of “sales”, “added value” and “production cost” are set to 1. If it is “little increasing”, the values of “sales”, “added value” and “production cost” are all set to 0.6. If it is “little decreasing”, the values of “sales”, “added value” and “production cost” are set to 0.3. If it is “decreasing”, the values of “sales”, “added value” and “production cost” are all set to 0.

If the parameter value environmental item “demand change” is “changing”, the values of “sales”, “added value” and “production cost” are set to 0.2, 0.5 and 0, respectively. If it is “little changing”, the values of “sales”, “added value” and “production cost” are all set to 0.5. If it is “stable”, the values of “sales”, “added value” and “production cost” are set to 0.8, 0.5 and 0.1, respectively.

Upon receipt of the environmental data 3, the evaluation calculation unit 63 selects each value of “sales”, “added value” and “production cost” from the evaluation table 71, based on the value of each environmental item of the environmental data 3, and calculates the total value of each evaluation item. The evaluation calculation unit 63 outputs this total value of each evaluation item to the data management unit 12 as environmental evaluation data.

Similarly, upon receipt of ideal environmental data 8, the evaluation calculation unit 63 selects each value of “sales”, “added value” and “production cost” from the evaluation table 71, based on the value of each environmental item of the ideal environmental data 8, and calculates the total value of each evaluation item. The evaluation calculation unit 63 outputs this total value of each evaluation item to the data management unit 12 as environmental evaluation data.

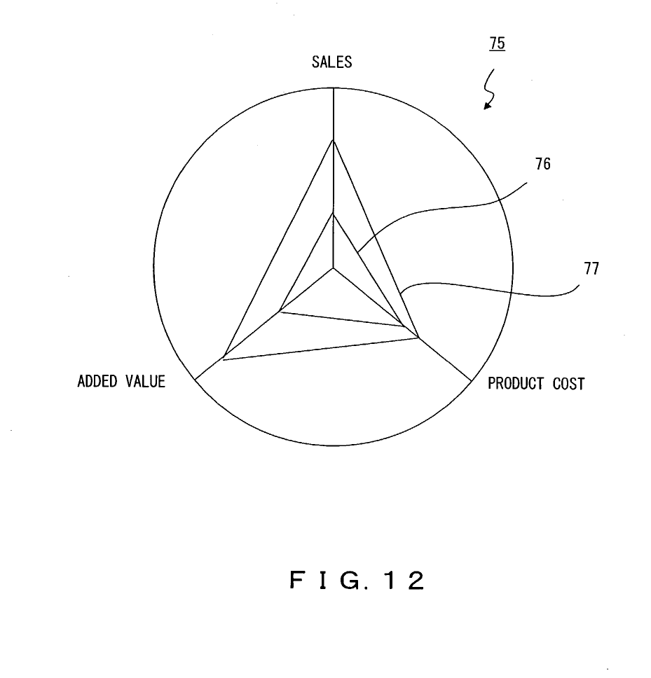

The data management unit 12 outputs the environmental evaluation data and ideal environmental evaluation data that are received from the evaluation calculation unit 63 to the input/output unit 11. The input/output unit 11 outputs the environmental evaluation data and ideal environmental evaluation data, for example, in the form of a radar chart. FIG. 12 shows example outputs of environmental evaluation data and ideal environmental evaluation data. In FIG. 12, environmental evaluation data 76 and ideal environmental evaluation data 77 forms a radar chart 75.

As described above, in the second preferred embodiment, since environmental evaluation data and ideal environmental evaluation data are calculated, based on environmental data 3 and ideal environmental data 8, respectively, evaluation before and after a candidate model is executed can be automatically calculated.

Although in this second preferred embodiment, three items of “sales”, “added value” and “production cost” are used for evaluation items, an arbitrary item can be used for the evaluation item, and the number of evaluation items can also be arbitrarily set.

Although in the second preferred embodiment, a model building device has been described, a model building program for enabling a computer to perform the same process can also be obtained by realizing the configuration of the model building device by software.

Furthermore, although in the second preferred embodiment, a model building device to be used to map out a strategy in a business field has been described, the present invention can be widely used to build a model in an environment where a plurality of factors are complicated and related.

[Third Preferred Embodiment]

In the third preferred embodiment, a computer system for executing a model building program with the same function as that of the model building device in the second preferred embodiment is described.

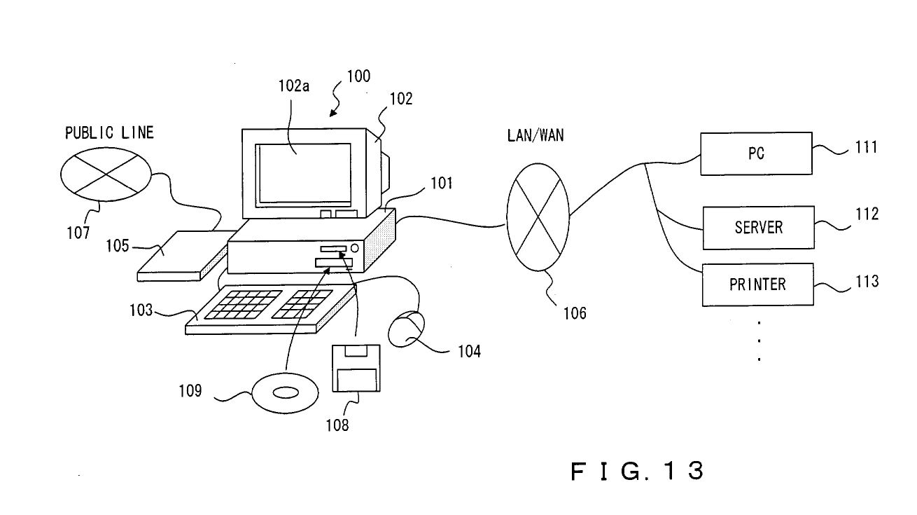

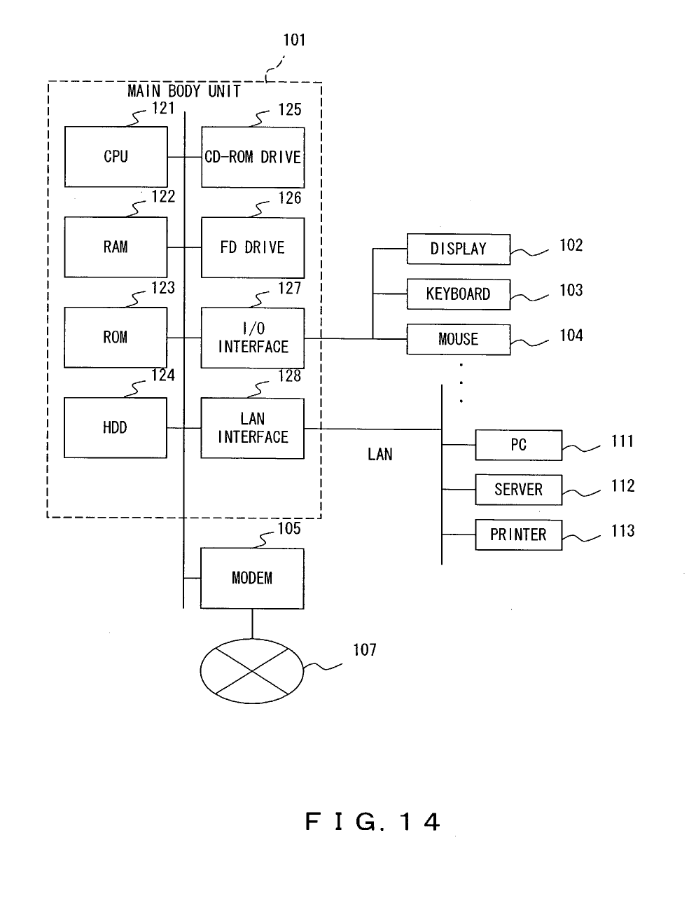

A computer system 100 shown in FIG. 13 comprises a main body unit 101, a display unit 102 displaying information, such as images and the like, on a monitor screen 102a according to instructions from the main body unit 101, a keyboard 103 inputting a variety of information to this computer system 100, a mouse 104 designating an arbitrary position on the monitor screen 102a of the display 102, a LAN interface connecting the computer system 100 to a local area network (LAN) 106 or a wide area network (WAN) and a modem 105 connecting the computer system 100 to a public line 107, such as the Internet and the like. In this case, the LAN 106 connects the computer system 100 to another computer system (PC) 111, a server 112, a printer 113 and the like. As shown in FIG. 14, the main body unit 101 comprises a CPU 121, a RAM 122, a ROM 123, a hard disk drive (HDD) 124, a CD-ROM drive 125, an FD drive 126, an I/O interface 127 and a LAN interface 128.

If a model building program is executed in this computer system 100, a model building program stored in a storage medium, such as a portable storage medium, for example, a flexible disk (FD) 108, a CD-ROM 109, a DVD disk, a magneto-optical disk, an IC card, etc., where the database of a server 112 is connected to the computer system 100, through a line using a modem 105 and a LAN interface, or to the database of another computer system (PC) 111, is installed in the computer system 100. The installed model building program is stored in the HDD 124 and the CPU 121 executes the program using a RAM 122, a ROM 123 and the like. Here, the storage medium includes a portable storage media, such as a CD-ROM 109, a flexible disk 108, a DVD disk, a magneto-optical disk, an IC card, etc.; storage media, such as a hard disk 124 internally and externally provided for the computer system 100; the database of the server 112 storing the model building program to be installed in the computer system 100,connected to the computer system 100 through the LAN 106; and another computer system's 111/database with a transmission medium to a public line 107.

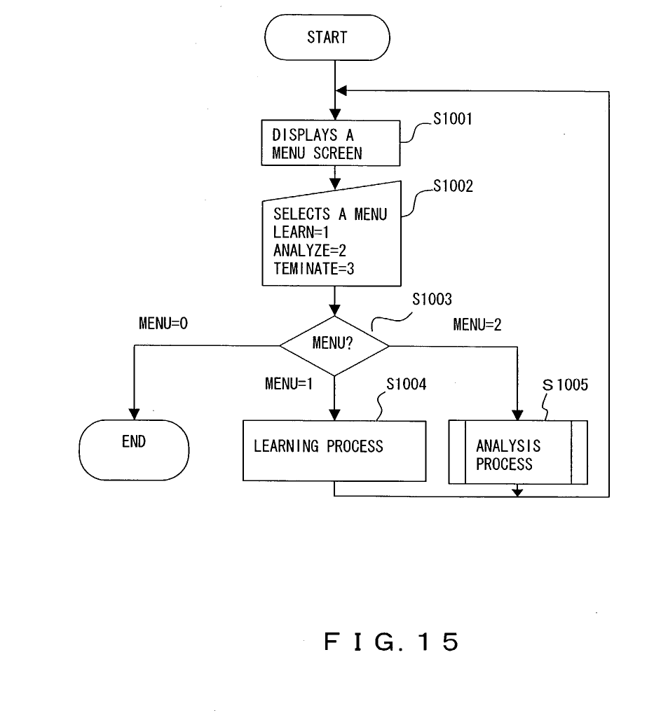

Next, a process performed when this model building program is executed in the computer system 100 is described in detail. FIG. 15 is a flowchart showing the control process performed in the computer system 100 when a model building program is executed. The contents of the process are described with reference to FIG. 15.

When the execution of this model building program is started, firstly, in step S1001, a menu screen is displayed on the monitor 102a.

Three choices of [1: Learn], [2: Analyze] and [3: Terminate] are shown on the menu screen as processes to be performed by the computer system 100. Indication for urging a user of the system to input the number attached to each choice as a result of the selection is also displayed.

The user selects a process, that is, inputs a number, operating the keyboard 103 or mouse 104. Then, in S1002, the computer system 100 recognizes the contents of this user's operation and obtains this inputted number indicating the result of the process selection.

In 51003, it is judged what number for a process S1002 has been obtained. If it is judged that 1 is obtained, specifically, a learning process is selected, the process proceeds to S1004. If it is judged that 2 is obtained, specifically, an analysis process is selected, the process proceeds to S1005. If it is judged that 0 is obtained, specifically, the termination process of the model building program is selected, the process shown in FIG. 15 is terminated.

In S1004, a learning process is performed. This process conducts the training of a neural network shown in FIG. 6. Specifically, the learning of a neural network according to the back propagation method described earlier is conducted by providing sample data for learning of each environmental item of the environmental data 3 as an input item, providing a candidate model 5 to be outputted from this neural network when this sample data for learning of the environmental item of the environmental data 3 is provided as the output item of the sample data for learning. A candidate model 5 and ideal environmental data 8 are provided for the input and output layers, respectively, and the learning of a neural network for calculating the relationship between the candidate model 5 and ideal environmental data 8 is also conducted.

After the process in S1004 is completed, the process returns to S1001 and the process described above is repeated.

In S1005, an analysis process is performed. This process is described in detail next.

After the process in S1005 is completed, the process returns to S1001 and the process described above is repeated.

By performing the control process described above, the computer system 100 can realize the same function of the model building device in the second preferred embodiment.

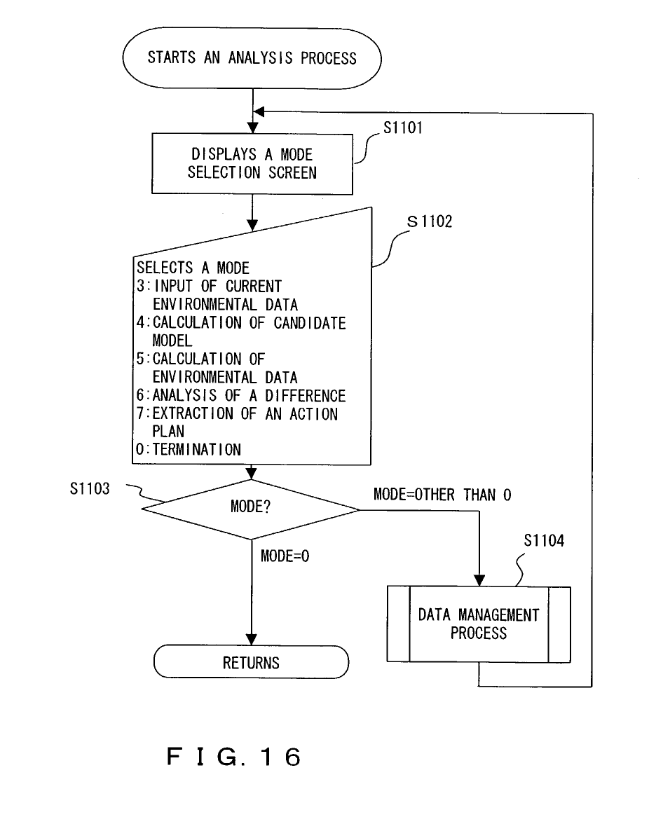

Next, the analysis process, which is the process in S1005 of the control process described above, is described. FIG. 16 is a flowchart showing this analysis process.

In FIG. 16, firstly, in S1101, a mode selection screen is displayed on the monitor 102a.

Seven choices of [3: Input of current environmental data], [4: Calculation of candidate model], [5: Calculation of environmental data], [6: Analysis of a difference], [7: Extraction of an action plan] and [0: Termination] are displayed as functions (operation modes) for the computer system 100 to perform by performing this analysis process. Indication for urging a user of the system to input the number attached to each choice as a result of the operation mode selection is also displayed.

A user selects an operation mode, specifically, inputs a number, operating the keyboard 103 or mouse 104. Then, in S1102, the computer system 100 recognizes the contents of this user's operation and obtains this inputted number indicating the result of the operation mode selection.

In S1103, it is judged what number for the process S1102 has been obtained. If it is judged that 0 is obtained, specifically, the termination of the current process is selected, this analysis process is terminated and the process returns to the control process shown in FIG. 15.

If in the decision process in S1103 it is judged that the process in S1102 obtains a number other than 0, specifically, another operation mode is selected, the process proceeds to S1104 and a data management process is performed. This process enables the computer system 100 to perform the same process as that of the data management unit 12. The data management process is described in detail next.

After the process in S1104 is completed, the process returns to S1101 and the process described above is repeated. So far the analysis process has been described.

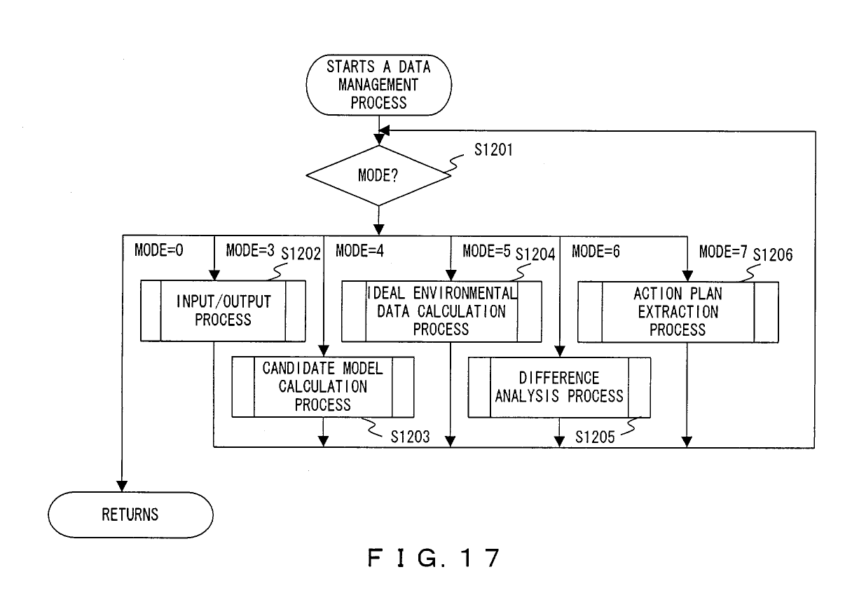

Next, the data management process, which is the process in S1104 of the analysis process described above, is described. FIG. 17 is a flowchart showing the data management process.

In FIG. 17, firstly, in S1201, it is judged which operation mode is currently selected. If it is judged that 0 is selected, this data management process is terminated and the process returns to the analysis process shown in FIG. 16.

If in the decision process of S1201 it is judged that 3 is selected, in S1202 an input/output process is performed. This process enables the computer system 100 to perform the same process as that of the input/output unit 11. This process is described in detail later.

If in the decision process of S1201 it is judged that 4 is selected, in S1203 a candidate model calculation process is performed. This process enables the computer system 100 to perform the same process as that of the candidate model calculation unit 13. This process is described in detail later.

If in the decision process of S1201 it is judged that 5 is selected, in S1204 an ideal environmental data calculation process is performed. This process enables the computer system 100 to perform the same process as that of the ideal environmental data calculation unit 15. This process is described in detail later.

If in the decision process of S1201 it is judged that 6 is selected, in S1205 a difference analysis process is performed. This process enables the computer system 100 to perform the same process as that of the difference analysis unit 16. This process is described in detail later.

If in the judgment process of S1201 it is judged that 7 is selected, in S1206 an action plan extraction process is performed. This process enables the computer system 100 to perform the same process of the action plan extraction unit 17. The details of this process are described later.

After one of the processes in S1202, S1203, S1204, S1205 and S1206 is completed, the process returns to S1201 and the process described above is repeated. So far the data management process has been-described.

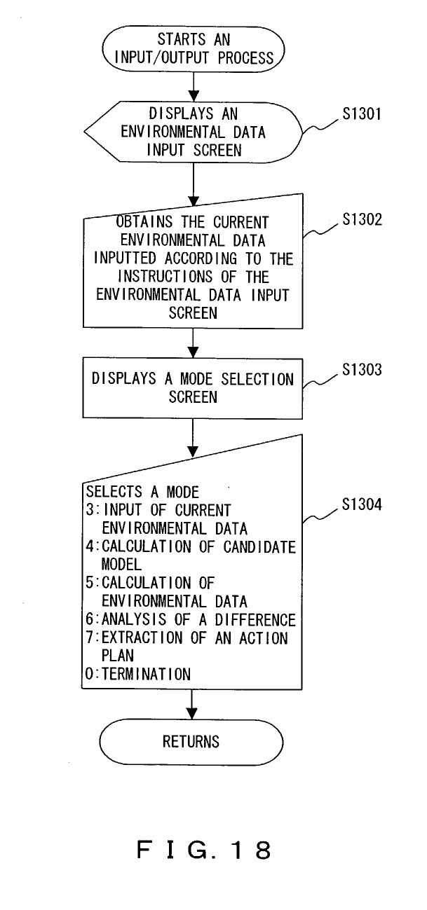

Next, the input/output process, which is the process in S1202 of the data management process described above, is described. FIG. 18 is a flowchart showing the input/output process.

In FIG. 18, firstly, in S1301, the environmental data input screen shown in FIG. 3 is displayed on the monitor 102a.

A user inputs environmental data 3 operating the keyboard 103 or mouse 104. Then, in S1302, the computer system 100 recognizes the contents of this user's operation and obtains the inputted environmental data 3 and stores the obtained environmental data 3 in the HDD 124.

In S1303, the mode selection screen described above is displayed on the monitor 102a. The user selects an operation mode, Specifically, inputs a number, operating the keyboard 103 or mouse 104, according to the instructions of the displayed mode selection screen. The computer system 100 recognizes the contents of this user's operation by a process in S1304 and obtains the inputted number.

After the process described above is completed, this input/output process is terminated and the process returns to the data management process shown in FIG. 17.

So far the input/output process has been described.

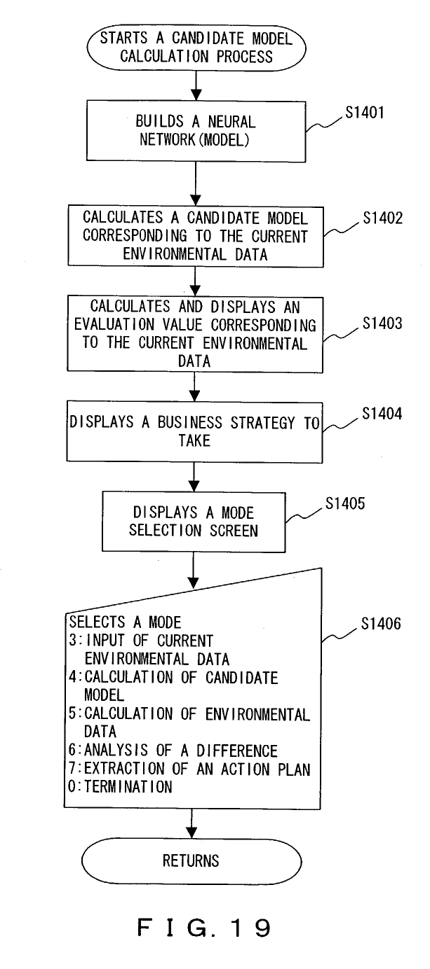

Next, the candidate model calculation process, which is the process in S1203 of the data management process described above, is described. FIG. 19 is a flowchart showing the candidate model calculation process.

In FIG. 19, firstly, in S1401, a process of building the neural network shown in FIG. 6 is performed. The connection between each input item and each neuron, the connection between each neuron and each output item and weight provided to each connection of the neural network built by this process are all already determined by performing the learning process described earlier in advance.

In S1402, the environmental data 3 stored in the HDD 124 is inputted to the neural network built by the process in S1401 and a candidate model 5 is calculated based on this environmental data 3.

In S1403, the evaluation value of each evaluation item is calculated based on the value of each environmental item of the environmental data 3 with reference to the evaluation table 71 shown in FIG. 11, and on the environmental evaluation data 76, which is the calculation result of this evaluation value, and is displayed in a form of a radar chart as shown in FIG. 12, on the monitor screen 102a. This process in S1403 enables the computer system 100 to perform the same process as that of the valuation calculation unit 63.

In S1404, the theoretically best business strategy of the relevant company, specifically a number indicating the theoretically best candidate model 5 of the relevant company is displayed on the monitor screen 102a.

In S1405, the mode selection screen described earlier is displayed on the monitor 102a. A user selects an operation mode, specifically inputs a number, operating the keyboard 103 or mouse 104, according to the instructions of the displayed mode selection screen. The computer system 100 recognizes the contents of this user's operation by a process in S1406 and obtains this inputted number indicating the result of the operation mode selection.

After the process described above is completed, this candidate model calculation process is terminated and the process returns to the data management process shown in FIG. 17.

So far the candidate model calculation process has been described.

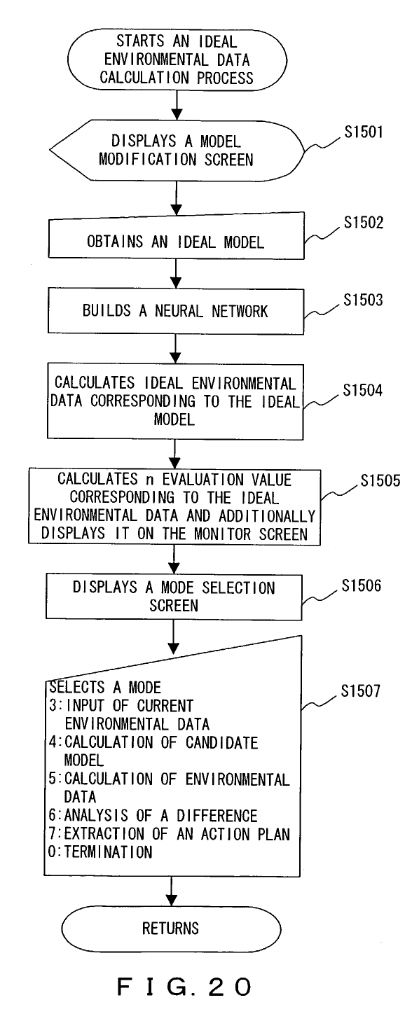

Next, the ideal environmental data calculation process, which is the process in S1204 of the data management process described earlier is described. FIG. 20 is a flowchart showing the ideal environmental data calculation process.

In FIG. 20, firstly, in S1501, a model modification screen is displayed on the monitor 102a. On the model modification screen, the theoretically best business strategy of the relevant company that is obtained by the candidate model calculation process is displayed as an initial value.

A user modifies this initial value, operating the keyboard 103 or mouse 104 according to the instructions of the displayed mode selection screen and sets a number indicating his company's ideal model, specifically a number indicating his company's practically best business strategy. The computer system 100 recognizes the contents of this user's operation by a process in S1502 and obtains the number indicating his company's ideal model.

In S1503, a neural network is built. The input and output layers of a neural network built by this process are provided with a candidate model 5 and ideal environmental data 8, respectively, and the connection between each input item and each neuron, the connection between each neuron and each output item and weight provided to each connection are all already determined by performing the learning process described earlier.

In S1504, the number indicating the ideal model of the relevant company obtained by the process in S1502 is inputted to the neural network built by the process in S1503, and the ideal environmental data 8 for realizing this ideal model is calculated.

In S1505, the evaluation value of each evaluation item is calculated based on the value of each environmental item of the calculated ideal environmental data 8 with reference to the evaluation table 71 shown in FIG. 11, and the ideal environmental evaluation data 77, which is the result of this evaluation value calculation, is additionally displayed in the form of the radar chart shown in FIG. 12 on the monitor screen 102a. This process in S1505 enables the computer system 100 to perform the same process as that of the evaluation calculation unit 63.

In S1506, the mode selection screen described earlier is displayed on the monitor 102a. A user selects an operation mode, specifically inputs a number, operating the keyboard 103 or mouse 104 according to the instructions of the displayed mode selection screen. The computer system 100 recognizes the contents of this user's operation by a process in S1507 and obtains this inputted number indicating the result of the operation mode selection.

After the process described above is completed, this ideal environmental data calculation process is terminated and the process returns to the data management process shown in FIG. 17.

So far the ideal environmental data calculation process has been described.

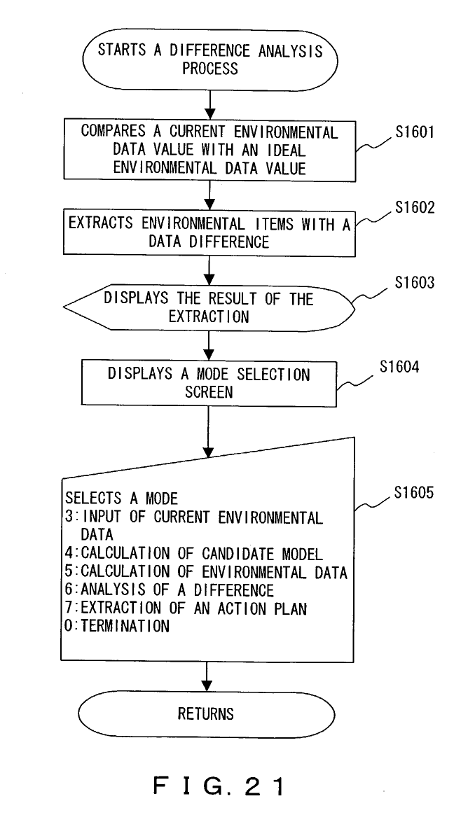

Next, the difference analysis process, which is the process in S1502 of the data management process, described earlier, is described. FIG. 21 is a flowchart showing the difference analysis process.

In FIG. 21, firstly, in S1601, the respective environmental item values of the environmental data 3 stored in the HDD 124 and the ideal environmental data 8 calculated by the ideal environmental data calculation process described earlier are compared. Then, in S1602, environmental items, each with a difference in value between the environmental data 3 and ideal environmental data 8, are extracted.

In S1603, the environmental items extracted by the process in S602 and the information indicating the contents of the difference, that is, the difference data is displayed on the monitor screen 102a.

In S1604, the mode selection screen described earlier is displayed on the monitor 102a. The user selects an operation mode, specifically input a number, operating the keyboard 103 or mouse 104 according to the instructions of the displayed mode selection screen. The computer system 100 recognizes the contents of this user's operation by a process in S1605 and obtains this inputted number indicating the result of the operation mode selection.

After the process described above is completed, this ideal environmental data calculation process is terminated and the process returns to the data management process shown in FIG. 17.

So far the difference analysis process has been described.

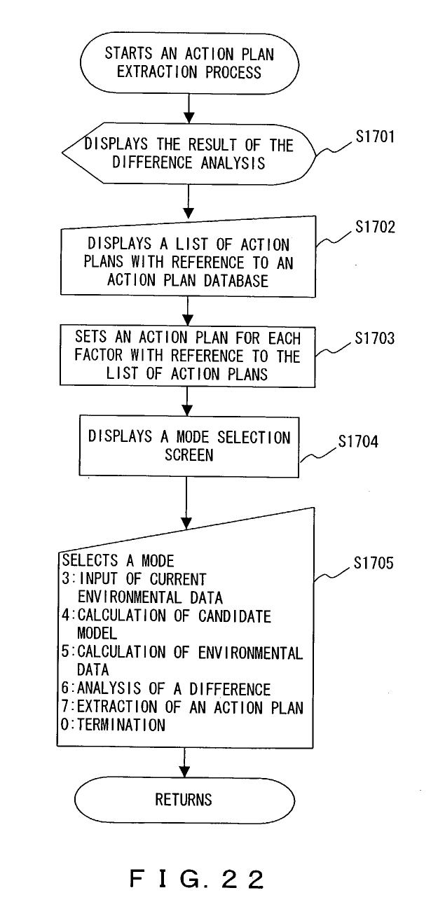

Next, the action plan extraction process, which is the process in S1206 of the data management process described earlier, is described. FIG. 22 is a flowchart showing the action plan extraction process.

In S1701, the list of the re-analysis result of the difference analysis process, specifically the environmental items each with a difference in value between the environmental data 3 and ideal environmental data 8, which are extracted by the difference analysis process, and the difference data indicating the contents of the difference are displayed on the monitor screen 102a.

In S1702, the action plan database 18 stored in the HDD 124 is referenced and an action plan corresponding to each environmental item and difference data described above, specifically an action plan effective in changing each parameter value of the environmental data 3 to that of the corresponding ideal environmental data 8, is extracted from the action plan database 18. Then, the extracted list of action plans is displayed on the monitor screen 102a.

A user modifies the displayed action plans, for example, makes them practicable, and resets the number indicating his company's practicable business strategy. The computer system 100 recognizes the contents of this user's operation by a process in S1703 and obtains this number. Then, in the execution of the ideal environmental data calculation process, this number is used as that indicating his company' ideal model.

In S1704, the mode selection screen described earlier is displayed on the monitor 102a. The user selects an operation mode, specifically input a number, operating the keyboard 103 or mouse 104 according to the instructions of the displayed mode selection screen. The computer system 100 recognizes the contents of this user's operation by a process in S1705 and obtains this inputted number indicating the result of the operation mode selection.

After the process described above is completed, this ideal environmental data calculation process is terminated and the process returns to the data management process shown in FIG. 17.

So far the action plan extraction process has been described.

As described above, in the third preferred embodiment, by executing every process described above by software, a general-purpose computer can realize the same effect as that of the model building device in the second preferred embodiment.

By executing a model building program for realizing the configuration of the model building device in the first preferred embodiment by software, a general-purpose computer can also realize the same effect as that of the model building device in the first preferred embodiment.

As described above, according to the present invention, since a target model indicating ideal environmental data is selected from a plurality of models and ideal environmental data indicating an environment suited for the execution of the selected target model, the ideal environment can be provided when a specific model is adopted, which greatly contributes to strategy formation by the planning department of an enterprise.

In the present invention, since a difference between environmental data and ideal environmental data is calculated as difference data and a practicable action plan for bringing the environmental data close to the ideal environmental data is outputted based on this difference data, a specific and detailed action plan needed when a specific model is adopted can be provided, which greatly contributes to strategy formation by the planning department of an enterprise.

Since in the present invention, a computer calculates an evaluation in a specific field based on environmental data and calculates the ideal evaluation in the specific field based on ideal environmental data when a selected model is adopted, a specific and detailed action plan needed when a specific model is adopted can be provided, which greatly contributes to strategy formation by the planning department of an enterprise.

What is claimed is:

1. A computer-readable storage medium, on which is recorded a model building program enabling a computer to select one or more models indicating a practicable plan in an environment indicated by environmental data, from a plurality of models as candidate models, based on environmental data used to judge the environment of a specific field and to output the models, wherein
said program comprising:
enabling the computer to select a target model indicating ideal environmental data from the plurality of models; and
enabling the computer to calculate ideal environmental data indicting an environment suited for the execution of the target model selected by the target model selection process.

2. The storage medium according to claim 1, wherein
the target model selection process enables the computer to select a target model indicating ideal environmental data from the plurality of candidate models.

3. The storage medium according to claim 1, wherein
the model building program further enables the computer to calculate a difference between the environmental data and the ideal environmental data as difference data.

4. The storage medium according to claim 3, wherein
the model building program further enables the computer to output a practicable action plan effective in bringing the environmental data close to the ideal environmental data, based on the difference data.

5. The storage medium according to claim 1, wherein
the model building program further enables the computer to perform a process, with said process comprising:
calculating evaluation data, indicating evaluation in the specific field, of the environmental data; and
calculating ideal environmental evaluation data indicating an evaluation in the specific field that is needed when the selected model is adopted, based on the ideal environmental data.

6. The storage medium according to claim 1, wherein
the ideal environmental data calculation process enables the computer to calculate the ideal environmental data using a neural network.

7. The storage medium according to claim 6, wherein
the candidate model is selected based on a result of the ideal environmental data calculation using the neural network.

8. The storage medium according to claim 1, wherein
the ideal environmental data calculation process enables the computer to calculate the ideal environmental data using a matrix specifying the relationship between the candidate model and the ideal environmental data.

9. A model building method for selecting one or more models indicating a practicable plan in the environment indicated by environmental data, from a plurality of models as candidate models, based on environmental data used to judge the environment of a specific field, and outputting the models, comprising:
selecting a target model indicating ideal environmental data from the plurality of models; and
calculating ideal environmental data indicting the environment suited for the execution of the target model selected by the target model selection step.

10. The model building method according to claim 9, wherein
in the selection of a target model, a target model indicating ideal environmental data is selected from the plurality of candidate models.

11. The model building method according to claim 9, further comprising
calculating a difference between the environmental data and the ideal environmental data as difference data.

12. The model building method according to claim 11, further comprising
outputting a practicable action plan effective in bringing the environmental data close to the ideal environmental data, based on the difference data.

13. The model building method according to claim 9, further comprising:
calculating evaluation data indicating evaluation in the specific field, of the environmental data; and
calculating ideal evaluation data indicating evaluation in the specific field needed when the selected model is adopted, based on the ideal environmental data.

14. The model building method according to claim 9, wherein
in the calculation of ideal environmental data, the ideal environmental data is calculated using a neural network.

15. The model building method according to claim 14, wherein
the candidate model is selected based on a result of the ideal environmental data calculation using the neural network.

16. The model building method according to claim 9, wherein
in the calculation of ideal environmental data, the ideal environmental data is calculated using a matrix specifying the relationship between the candidate model and the ideal environmental data.

17. A model building device for selecting one or more models indicating a practicable plan in the environment indicated by environmental data from a plurality of models as candidate models, based on environmental data used to judge the environment of a specific field, and outputting the models, comprising:
a target model selection unit selecting a target model indicating ideal environmental data from the plurality of models; and
an ideal environmental data calculation unit calculating ideal environmental data indicting the environment suitable for the execution of the target model selected by the target model selection unit.

18. The model building device according to claim 17, wherein
said target model selection unit selects a target model indicating the ideal environmental data from the plurality of candidate models.

19. The model building device according to claim 17, further comprising
a difference calculation unit calculating a difference between the environmental data and the ideal environmental data as difference data.

20. The model building device according to claim 19, further comprising
an action plan output unit outputting a practicable action plan effective in bringing the environmental data close to the ideal environmental data, based on the difference data.

21. The model building device according to claim 17, further comprising:
an evaluation calculation unit calculating evaluation data indicating evaluation in the specific field, of the environmental data; and
an ideal evaluation calculation unit calculating ideal evaluation data indicating evaluation in the specific field needed when the selected model is adopted.

22. The model building device according to claim 17, wherein
said ideal environmental data calculation unit calculates the ideal environmental data using a neural network.

23. The model building device according to claim 22, wherein
the candidate model is selected based on the result of the ideal environmental data calculation using the neural network.

24. The model building device according to claim 17, wherein
said ideal environmental data calculation unit calculates the ideal environmental data using a matrix specifying the relationship between the candidate model and the ideal environmental data.

25. A computer data signal embodied in a carrier wave and representing a model building program enabling a computer to select one or more models indicating a practicable plan in the environment of the environmental data, based on environmental data used to judge the environment in a specific field, wherein
said program comprising:
enabling the computer to select a target model indicating ideal environmental data from the plurality of models; and
enabling the computer to calculate ideal environmental data indicating the environment suitable for the execution of the target model selected by the target model selection process.

26. A model building device for selecting one or more models indicating a plan practicable in the environment indicated by environmental data from a plurality of models as candidate models, based on environmental data used to judge the environment of a specific field and outputting the models, comprising:
a target model selection means for selecting a target model indicating ideal environmental data from the plurality of models; and
an ideal environmental data calculation means for calculating ideal environmental data indicting the environment suitable for the execution of the target model selected by the target model selection means.

27. A model building program enabling a computer to select one or more models indicating a practicable plan in the environment of the environmental data, based on environmental data used to judge the environment in a specific field, wherein
said program comprising:
enabling the computer to select a target model indicating ideal environmental data from the plurality of models; and
enabling the computer to calculate ideal environmental data indicating the environment suitable for the execution of the target model selected by the target model selection process.
